(19) United States
(12) Patent Application Publication
(10) Pub. No.: US 2003/0191825 A1
(43) Pub. Date: Oct. 9, 2003

(54) Network composing apparatus specifying method, system for executing the method, and program for processing the method

(75) Inventors: Fumi Miyazaki, Kawasaki (JP); Ryoji Furuhashi, Yokohama (JP); Yasunori Kaneda, Sagamihara (JP)

Correspondence Address: HOGAN & HARTSON L.L.P., 500 S. GRAND AVENUE, SUITE 1900, LOS ANGELES, CA, 90071-2611, US

(73) Assignee: HITACHI, LTD.

(21) Appl. No.: 10/300,267

(22) Filed: Nov. 20, 2002

(30) Foreign Application Priority Data
Apr. 4, 2002 (JP) 2002-102512

(51) Int. Cl. G06F 15/177

(52) U.S. Cl. 709/220; 709/233

(57) ABSTRACT

A method for specifying an apparatus among a plurality of apparatuses composing a network. The method comprises the steps of transmitting an apparatus identifier for identifying an apparatus composing the network, receiving the apparatus identifier transmitted from the apparatus, referring to an apparatus information table indicating correlation between apparatus identifiers of the plurality of apparatuses composing the network and patterns arranged in a network configuration diagram, searching for a pattern corresponding to the apparatus identifier received, and creating a screen image indicating which of the patterns in the network configuration diagram corresponds to the searched pattern.

### 1. FIELD OF THE INVENTION

The present invention relates to a network composing apparatus specifying system that specifies apparatuses composing a network, which correlates icons arranged in a topology diagram representing the network configuration to the actual apparatuses, and more particularly to a network composing apparatus specifying system that is effective in specifying apparatuses composing a storage network.

### 2. DESCRIPTION OF RELATED ART

In conventional computer systems, storage apparatuses were configured to be directly connected to the respective computers, with the storage apparatuses directly linked to the respective computers to play the role of their memory apparatuses. However, with the increase in the volume of stored information, and when the computer system migrates to a large-scale system that may connect computers and storage apparatuses through a network such as a local area network (LAN), it has become necessary to manage a large number of computers and storage apparatuses. Thus, as the scale of the system expanded, it posed a problem of increasing total cost of ownership (TCO).

Because of this, more and more corporations are installing systems using Storage Area Networks (SANs) which are capable of collectively managing storage apparatuses dispersed over a network. A SAN may be a storage area network that connects groups of computers and groups of storage apparatuses using fibre channels in which the plurality of storage apparatus groups are physically integrated, and the plurality of computer groups can use storage regions (volumes) of the storage apparatus groups through the network. A SAN has a very important role of not only physically integrating groups of storage apparatuses but also integrating their management. Because of this, storage administrators in a corporation can collect the volumes used by a number of computers and mange the same by utilizing tools that are effective in managing the network system with the SAN, thus reducing the cost for managing storage apparatuses.

The important tasks for managing a storage network are topology management and fault management for managing the operating conditions of the apparatuses subject to management. In the topology management, in many cases, a topology diagram is displayed on the screen of a management console. The topology diagram expresses a network configuration with icons representing apparatuses and line segments representing the connection status of the apparatuses. In the fault management, in many cases, the topology diagram displayed on the screen of the management console indicates faults of apparatuses by, for example, reversing the background colors of icons representing the failed apparatuses. When managing the storage network, the administrator confirms the faulty apparatus through the management console screen and must actually go to the faulty apparatus to remove the failure and rectify the problem. Because of this, conventional management tools are often equipped with a unit to correlate the icons with the actual apparatuses.

Under the conventional technology, in order to correlate the icons in the configuration diagram displayed on the display screen to the actual apparatuses composing the network, the administrator refers to the status of positions of the icons in the configuration diagram to thereby trace wirings such as cables connecting the apparatuses composing the network, and specifies the apparatus. This method, however, poses a problem of taking up considerable time for specifying the apparatus when the wirings being traced are complex.

Moreover, in the above conventional technology, if the installation position of an apparatus composing the network is altered for some reasons, the administrator may encounter the problem of, for example, having to retrace the wirings, if the apparatus does not exist on the installation site stored in the data base or on the position overlapping the icon indicating the zone where the apparatus is installed, because the information concerning the altered installation site is not automatically reflected in the display unit.

If the administrator requires time to specify the faulty apparatus after verifying the fault information of the apparatus in the configuration diagram displayed on the management console screen, it would take time to restore the faulty apparatus to its normal state. This would not only affect storage management, but also lead directly to the problem of increasing the total cost of ownership (TCO).

### SUMMARY OF THE INVENTION

The present invention solves the above problems, and provide a technology that can improve the efficiency of managing and operating the network.

The present invention pertains to a network management system that specifies an apparatus among a plurality of apparatuses that compose the network, which correlates a pattern representative of the apparatus disposed in a network configuration diagram to the actual apparatus.

In a network management system in accordance with an embodiment of the present invention, an apparatus information table is created to store apparatus identifiers unique to respective apparatuses composing the network, icons that are patterns representing the apparatuses, fault information that indicate whether or not the apparatuses are faulty, and information of the apparatuses connected. A topology diagram is created to serve as a configuration diagram based on these information, and is displayed on portable or stand alone management consoles.

Also, each of the apparatuses composing part of the network configuration may transmit the apparatus identifier for identifying the apparatus from an apparatus identifier transmitter installed on the surface of the apparatus by using short-distance wireless communication or the like to notify a portable type management console located near the apparatus to identify the apparatus.

In the event one of the apparatuses composing the network fails, and the occurrence of the failure is shown at the icon in the topology diagram displayed on the management console, the administrator may have a portable management console display the topology diagram thereon, go to an installation site where the apparatus is installed, and specify the faulty apparatus by placing the portable management console close to each of the apparatuses.

More specifically, the portable management console receives an apparatus identifier transmitted by any one of the apparatuses approached, and searches for an icon that corresponds to the apparatus identifier by referring to the apparatus information table. Then, the portable management console may create and display a topology diagram that indicates the retrieved icon with a colored line frame (for example, a red line frame) or the like added thereto.

By examining whether the icon with the fault indication matches the retrieved icon that is framed in colored line, the administrator is able to determine whether or not the apparatus immediately before him is the apparatus with the fault.

In the present invention, an apparatus identifier transmitter, which is a transmitting unit, that transmits a signal of the respective apparatus identifier, and a communicating position indicator that indicates the position of the apparatus identifier transmitter may be placed on the surface of each of the apparatuses. The administrator may confirm the position of the apparatus identifier transmitter with the communicating position indicator placed on the surface of the apparatus. And, by bringing an apparatus identifier receiver section of the portable management console close to the communicating position indicator or in contact with the indicator, the administrator is able to securely establish short-distance wireless communication between the portable management console and each the apparatuses composing the network.

In the network management system of the present invention, the apparatus identifier of the apparatus that is selected by clicking the corresponding icon on the topology diagram is acquired from the portable management console. And, the network management system may transmit a request to execute a display of an apparatus identification for identifying the apparatus to the apparatus to be identified with the acquired apparatus identifier.

Upon receiving the request to execute the display of the apparatus identification, the apparatus may operate an apparatus identifying section installed on the apparatus, such as a light emitting unit, to perform the indication to identify the apparatus. With this, the administrator selects one of the icons on the management console screen to verify the indication of the apparatus corresponding to the icon, to thereby specify the apparatus corresponding to the icon.

As described above, in the management of network, such as the storage network, etc., the present invention correlates apparatuses composing the network that are expressed with icons on the topology diagram on the management console screen to the actual apparatuses composing the physical network. Therefore, it is possible to provide an operational management environment that assures efficient identification of an apparatus composing the network when fault information is confirmed concerning any of the apparatuses that can be verified on the topology diagram.

Moreover, in the present invention, the actual apparatuses composing the physical network display which of the icons in the topology diagram corresponds to the respective apparatuses. Therefore, even when a fault cannot be verified in the topology diagram on the management console, and an anomaly is detected in any of the apparatuses composing the network, it is possible to specify icons that correspond to the faulty apparatuses on the topology diagram on the management console.

Also, in the present invention, it is possible to specify the apparatuses at all times in an efficient manner, regardless of any movements of apparatuses composing the network because the apparatuses are specified by using the apparatus identifiers received from the respective apparatuses composing the network, and not by using the location information stored in the data base, etc.

Thus, with the network composing apparatus specifying system in accordance with the present invention, patterns representative of apparatuses arranged in a diagram of the network configuration and the actual apparatuses are correlated with one another. As a result, it is possible to enhance the efficiency when managing and operating the network.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

FIG. 1 shows an example of a system structure of a network composing apparatus specifying system in accordance with a first embodiment of the present invention.

FIG. 2 schematically shows a structure of a portable management console 112 in accordance with the first embodiment of the present invention.

FIG. 3 schematically shows a structure of a management console 111 in accordance with the first embodiment of the present invention.

FIG. 4 schematically shows a structure of a management server apparatus 106 in accordance with the first embodiment of the present invention.

FIG. 5 schematically shows a structure of a communication control section 500 in accordance with the first embodiment of the present invention.

FIG. 6 shows an example of apparatus placement where a group of server apparatuses, a group of storage apparatuses and an FC switch are placed on shelves in accordance with the first embodiment of the present invention.

FIG. 7 shows an example of data for apparatus information of a group of server apparatuses, a group of storage apparatuses and an FC switch in accordance with the first embodiment of the present invention.

FIG. 8 shows an example of data for connection information of an FC switch 103 in accordance with the first embodiment of the present invention.

FIG. 9 shows an example of apparatus information of a group of apparatuses and information of connected apparatuses which are subject to the management in accordance with the first embodiment of the present invention.

FIG. 10 shows an example of a topology diagram displayed on a management console screen 115 or a mobile management console screen 116 in accordance with the first embodiment of the present invention.

FIG. 11 is a flowchart of processing steps of a network composing apparatus specifying process in accordance with the first embodiment of the present invention.

FIG. 12 shows an example of system structure of a network composing apparatus specifying process in accordance with a second embodiment of the present invention.

FIG. 13 is a flowchart of processing steps of a network composing apparatus specifying process in accordance with the second embodiment of the present invention.

### DESCRIPTION OF PREFERRED EMBODIMENTS

The following is an explanation of an apparatus specifying system that may specify an individual apparatus among a plurality of apparatuses composing a network (hereafter referred to as a “network composing apparatus specifying system”). The network composing apparatus specifying system in accordance with a first embodiment specifies which apparatus that composes part of a storage network corresponds to an apparatus icon among a plurality of icons indicated in a topology diagram.

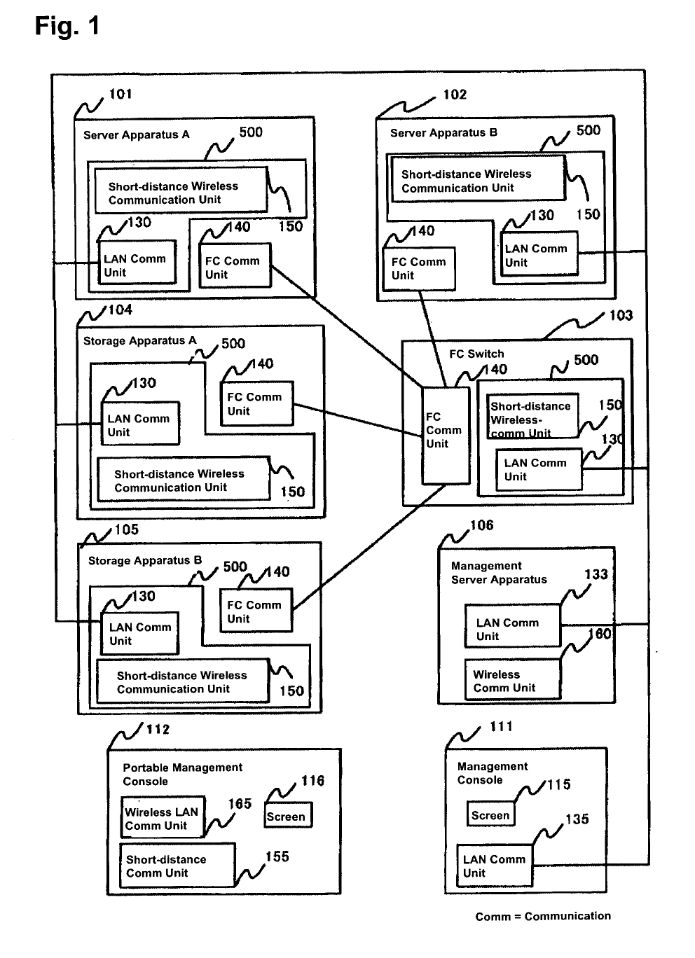

FIG. 1 is a diagram showing an example of the system configuration of the network composing apparatus specifying system of the present embodiment. The network composing apparatus specifying system is formed from at least one group of apparatuses that composes a network (i.e., network composing apparatuses), including at least one portable management console 112, a group of server apparatuses (e.g., server apparatus A101, server apparatus B 102), an FC switch 103 (fibre channel switch), a group of storage apparatuses (e.g., storage apparatus A 104, storage apparatus B 105), a management server apparatus 106 and a management console 111.

By using either the management console 111 or the portable management console 112, the administrator is able to perform topology management and fault management of the group of apparatuses (hereafter referred to as an “apparatus group”, with the individual apparatus being referred to as an “apparatus”) including the server apparatus A 101, the server apparatus B 102, the FC switch 103, the storage apparatus A104 and the storage apparatus B105.

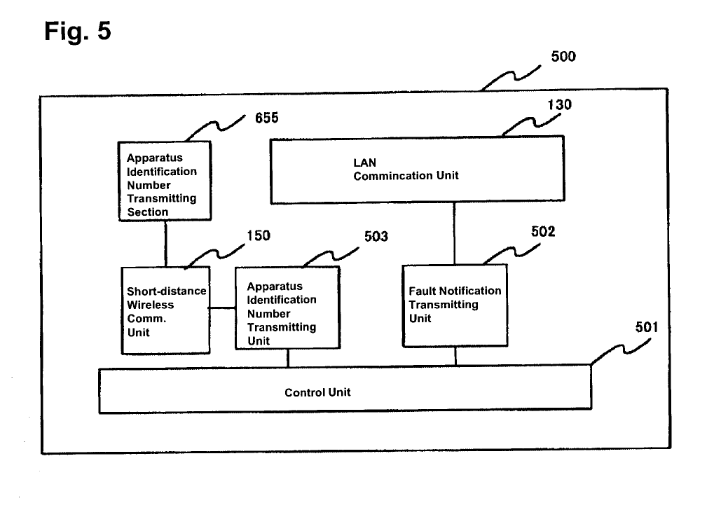

Each of the server apparatus A 101, the server apparatus B 102, the FC switch 103, the storage apparatus A 104 and the storage apparatus B 105 is equipped with a FC communication unit 140, which are connected to the FC switch 103 by using fibre channels. Each of the apparatuses is quipped with a communication control section 500 shown in FIG. 5, respectively.

In this embodiment, the FC switch has four ports for connecting with apparatuses, and the apparatuses are connected by fibre channel cables.

The network composing apparatuses, excluding the portable management console 112, have LAN communication units 130, 133 are 135, respectively, which are connected via the Ethernet cable to the apparatuses excluding the portable management console 112. The portable management console 112 and the management server apparatus 106 communicate with each other using wireless LAN communication units 160 and 165.

Since the management server apparatus 106 is equipped with the LAN communication unit 133 and the wireless LAN communication unit 160, apparatus information and apparatus connection information possessed by the management server apparatus 106 can be used by apparatuses with different portability. In other words, the management console 111 is able to use apparatus information and apparatus connection information possessed by the management server apparatus 106 by using the LAN communication unit 135, and the portable management console 112 is able to use the same information by using the wireless LAN communication unit 165. In this case, the information will be consistent because the management console 111 and the portable management console 112 create the same topology diagrams based on the apparatus information and apparatus connection information of the management server apparatus 106.

That is, the administrator may verify the same topology diagram displayed in the management console screen 115 and on the portable management console screen 116. And, if it is within the wireless LAN communication range with the management server apparatus 106, it is possible to constantly display the topology diagram without being restricted by cables or the like in terms of the need for reconnection or the length of the cables. To utilize the merits of such wireless communication, the present embodiment implements wireless LAN for the portable management console 112 and the management server 106.

Moreover, even when the apparatus groups are dispersed over a wide area, such as being located in different stories of a building, information on various apparatuses centralized in the management server apparatus 106 can be used with the portable management console 112 through a relay point for wireless LAN communication that may be installed on each floor.

The reason for using short-range wireless communication in the communication between the apparatuses and the portable management console 112 is because, when the administrator carries the portable management console 112 to try to specify the apparatuses, the short-range wireless communication is considered the most effective means to perform the tasks because no significant amount of time is required to single out an apparatus as there is no need to have direct connection with the apparatus, unlike cabled communication systems.

While the configuration in FIG. 1 connects the server apparatus group and the storage apparatus group with fibre channel cable and the FC switch 103, the present embodiment is not constrained by this configuration. The server apparatus group and storage apparatus group can be connected by Ethernet, and the fibre channel cable and the FC switch 103 can be linked by a separate FC switch.

The short-distance wireless communication units 150 and 155 between the apparatus groups and the portable management console 112 in this embodiment shall be explained as Bluetooth units. This short-distance wireless communication units do not necessarily have to be limited to the Bluetooth units. The communication units can use IrDA, the communications standard using infrared rays, wired connection using LAN communications units, or direct connection by using cables that directly connect the portable management console 112 and the apparatuses.

Also, while the wireless LAN communication units 160 and 165 between the management server apparatus 106 and the portable management console 112 may meet the IEEE802.11b standards, a direct connection may be used for connecting the portable management console 112 and the management server apparatus 106 by a wired communication unit such as LAN communication units.

In the present embodiment, an apparatus identification number shall be used as the apparatus identifier for identifying each of the apparatuses composing the network. In this example, Media Access Control (MAC) addresses shall be used as the apparatus identification numbers. However, for the sake of simplification, the MAC addresses for the server apparatus A 101, the server apparatus B 102, the FC switch 103, the storage apparatus A 104 and the storage apparatus B 105 shall be referred to as “101”, “102”, “103”, “104” and “105”, respectively

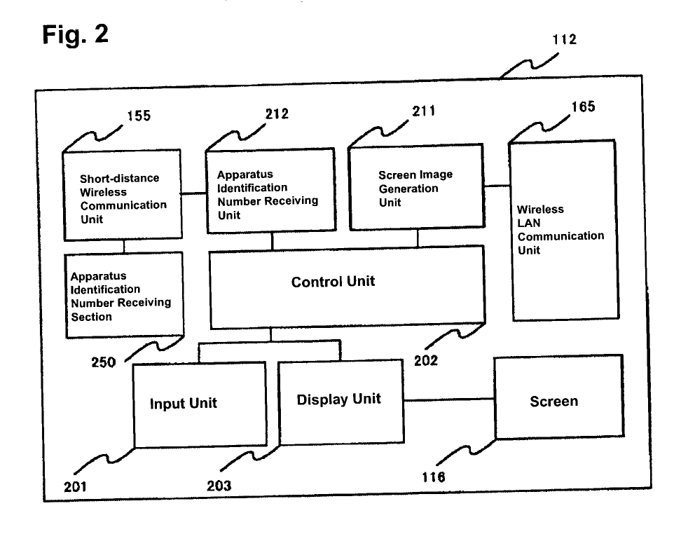

FIG. 2 schematically shows a diagram a structure of the portable management console 112 of the present embodiment. As shown in FIG. 2, the portable management console 112 has a screen image generating unit 211 and an apparatus identification number receiving unit 212.

The screen image generating unit 211 is a processing section that refers to an apparatus information table that indicate correlations between apparatus identification numbers of the respective apparatuses and their corresponding icons arranged in the topology diagram, searches for a icon corresponding with an apparatus identification number received by the apparatus identification number receiving unit 212, and generates a screen image that shows which of the icons in the topology diagram corresponds to the icon retrieved. The apparatus identification number receiving unit 212 is a processing section that receives the apparatus identification numbers from the apparatuses.

The screen image generating unit 211 and the apparatus identifier number receiving unit 212 can be implemented by a program. In this case, the program renders the portable management console 112 to function as the screen image generating unit 211 and the apparatus identifier number receiving unit 212. Such program shall be stored in a recording medium such as a non-volatile memory. Also, the medium to store the aforementioned program may be a medium other than a non-volatile memory. Moreover, the program may be transferred from the recording medium onto an information processing apparatus for use, or the program may be used by accessing the recording medium through the network.

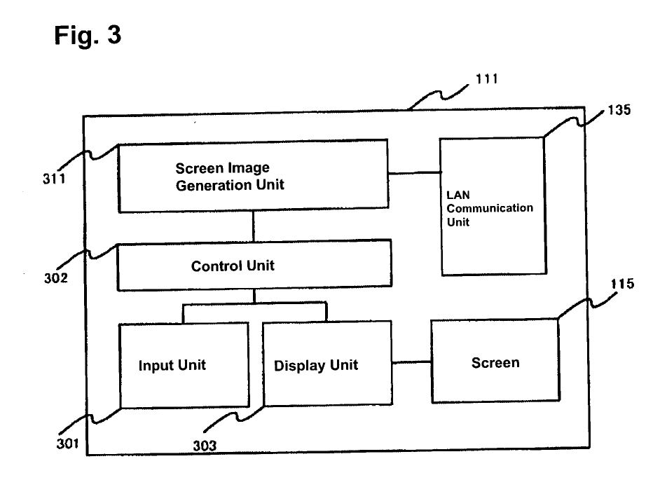

FIG. 3 schematically shows a diagram of a structure of the management console 111 of the present embodiment. As shown in FIG. 3, the management console 111 of this embodiment incorporates a screen image generating unit 311. This screen image generating unit 311 is a process section that creates and displays a topology diagram that shows the network configuration by referring to the apparatus information table showing correlations between the apparatus identifier numbers of the respective apparatuses and their icons.

The screen image generating unit 311 may be implemented by a program that allows the management console 111 to function as the screen image generating unit 311. The program may be recorded in a storage medium such as a CD-ROM medium or a magnetic disk, and is executed after it is loaded onto the memory. Also, other recording media instead of the CD-ROM or the magnetic disk may be used to record the program. The program may be used after installing it from the recording medium to an information processing apparatus, or the program may be used by accessing the recording medium through the network.

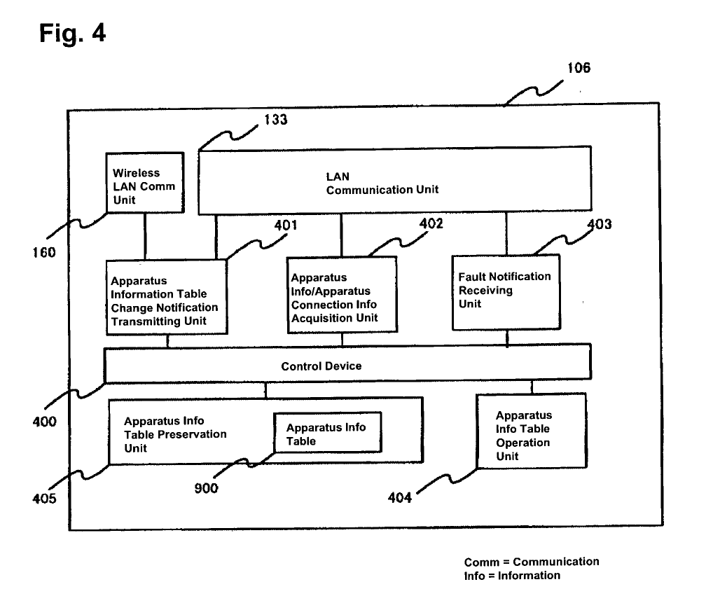

FIG. 4 schematically shows a diagram of a structure of the management server apparatus 106 of the present embodiment. As shown in FIG. 4, the management server apparatus 106 includes an apparatus information table change notification unit 401, an apparatus information and apparatus connection information acquiring unit 402, a fault notification receiving unit 403, an apparatus information table control unit 404 and an apparatus information table preservation unit 405.

The apparatus information table change notification unit 401 is a processing section that transmits notifications of changes taking place in the apparatus information table 900 to the management console 111 or the portable management console 112. The apparatus information and apparatus connection information acquiring unit 402 is a processing section that obtains apparatus information, including the identification numbers of apparatuses and the connecting apparatus information of remote apparatuses connected thereto.

The fault notification receiving unit 403 is a processing section that receives fault information from each of the respective apparatuses as to whether there is a problem causing the fault in the apparatus. The apparatus information table control unit 404 is a processing section that generates an apparatus information table 900 which shows the apparatus identification number of each of the apparatuses, the fault information and remote apparatuses connected to the apparatus. The apparatus information table preservation unit 405 is a processing section that preserves the generated aforementioned apparatus information table 900 in the management server apparatus 106.

The apparatus information table change notification transmitting unit 401, the apparatus information and apparatus connection information receiving unit 402, the fault notification receiving unit 403, the apparatus information table control unit 404 and the apparatus information table preservation unit 504 may be implemented by a program that renders the management server apparatus 106 to function as the apparatus information table change notification transmitting unit 401, the apparatus information and apparatus connection information receiving unit 402, the fault notification receiving unit 403, the apparatus information table control unit 404 and the apparatus information table preservation unit 504. The program is executed after it is recorded in a recording medium such as a CD-ROM or a magnetic disk. Also, other recording media instead of the CD-ROM or the magnetic disk may be used to record the program. The program may be used after it is installed from the recording medium onto an information processing apparatus, or after accessing the program on the said recording medium via the network.

FIG. 5 schematically shows a diagram of a configuration of the communication control section 500 of the present embodiment. As shown in FIG. 5, the communication control section 500 that composes part of the network in accordance with the present embodiment incorporates a fault notification transmitting unit 502 and an apparatus identification number transmitting unit 503.

The fault notification transmitting unit 502 is a processing section that transmits to the management server apparatus 106 fault information indicative of whether the apparatus has a fault problem. The apparatus identification number transmitting unit 503 is a processing section that transmits the apparatus identification number that identifies the apparatus.

The fault notification transmitting unit 502 and apparatus identification number transmitting unit 503 may be implemented by a program that renders the network composing apparatus to function as the fault notification transmitting unit 502 and apparatus identification number transmitting unit 503. The program may be executed after it is recorded in a recording medium such as a non-volatile memory. The media for recording the program needs not be a non-volatile memory, but any other memory unit. Also, the program may be used by installing it on an information processing apparatus from the recording medium, or after accessing the program of the recording media via the network.

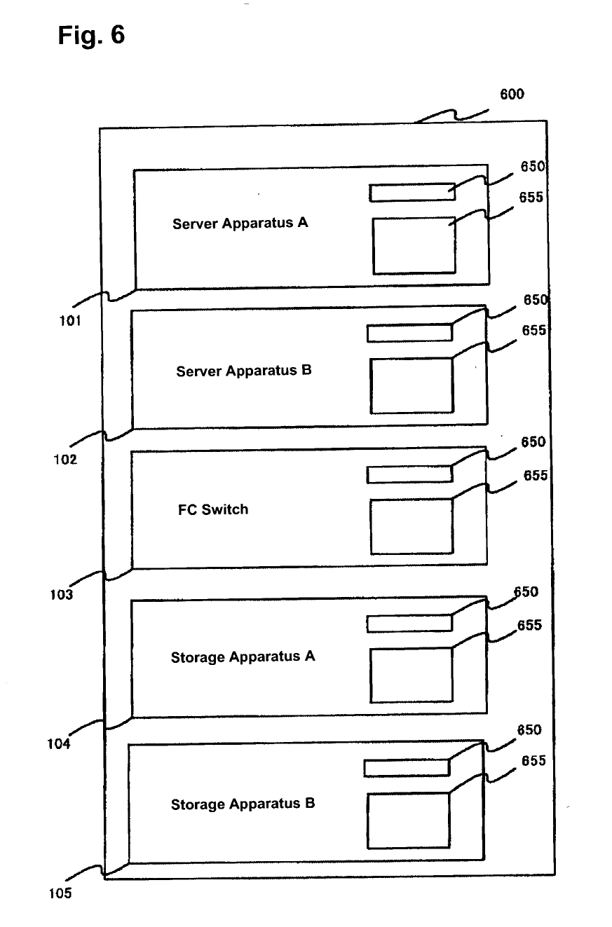

FIG. 6 is a diagram showing an example of how the group of server apparatuses, the group of storage apparatuses and the FC switch are arranged in shelves in accordance with the present embodiment. As shown in FIG. 6, each of the apparatuses in this embodiment has a communication section position indicator 650 and an apparatus identification number transmitting section 655.

The communication section position indicator 650 is an indicator provided on the apparatus surface indicating the position of the apparatus identification number transmitting section 655.

FIG. 6 shows the physical positions of the server apparatus A 101, the server apparatus B 102, the FC switch 103, the storage apparatus A 104 and the storage apparatus B 105 arranged in parallel on the shelf 600.

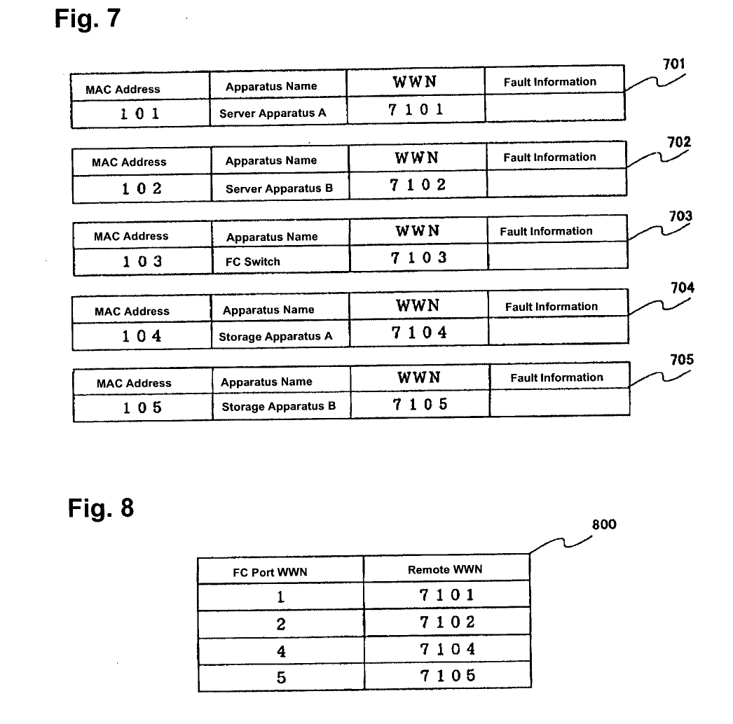

FIG. 7 shows an example of apparatus information data for the group of server apparatuses, the group of storage apparatuses and the FC switch in present embodiment. Each of the apparatus information in this embodiment shown in FIG. 7 includes at least a MAC address, the name of apparatus, World Wide Name (WWN) and fault information.

The World Wide Names of the respective apparatuses such as “7101”, “7102”, “7103”, “7104” and “7105” are provided here by, for the sake of simplification, attaching a number “7” to each of the MAC address numbers for the server apparatus A 101, the server apparatus B 102, the FC switch 103, the storage apparatus A 104, the storage apparatus B 105 of FIG. 1.

Moreover, in this embodiment, the fault information indicates information on fault location and contents of the fault in the apparatus, and no fault information shall be entered in the fault columns from 701 to 705 if there are no fault problems.

FIG. 8 shows an example of connection information data 800 for the FAC switch 103 in this embodiment. As shown in FIG. 8, WWN is used to express the state of connection of the respective apparatuses with the FC switch 103. For the sake of simplification, the WWN of each of the ports for the FC switch 103 is given the number “1”, “2”, “4” and “5”, respectively, in this embodiment. From the apparatus connection information 800, it can be verified that the ports for the FC switch 103 are connected to the apparatuses with WWN of “7101”, “7102”, “7104” and “7105”, respectively.

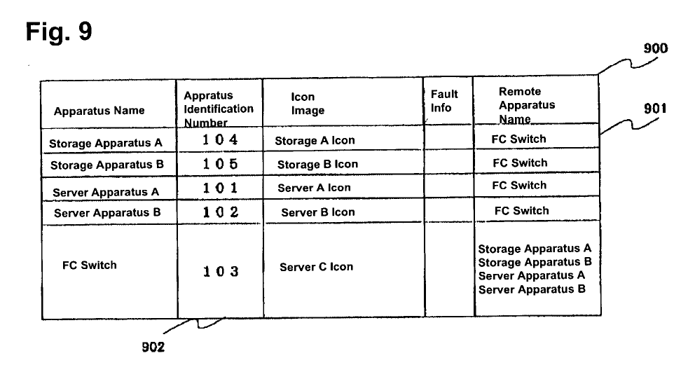

FIG. 9 shows an example of connected apparatus information and apparatus information for the group of apparatuses subject to management under the present embodiment. An apparatus information table 900 shown in FIG. 9 stores names of the apparatuses, identification numbers for identifying the respective apparatuses, icon images of patterns that represent the respective apparatuses when the apparatuses are presented by drawing, fault information concerning whether each of the apparatuses has a fault problem, and names of remote apparatuses connected to each of the apparatuses. In this apparatus information table 900, the names of the remote apparatuses are expressed in the names of the apparatuses rather than with the WWN.

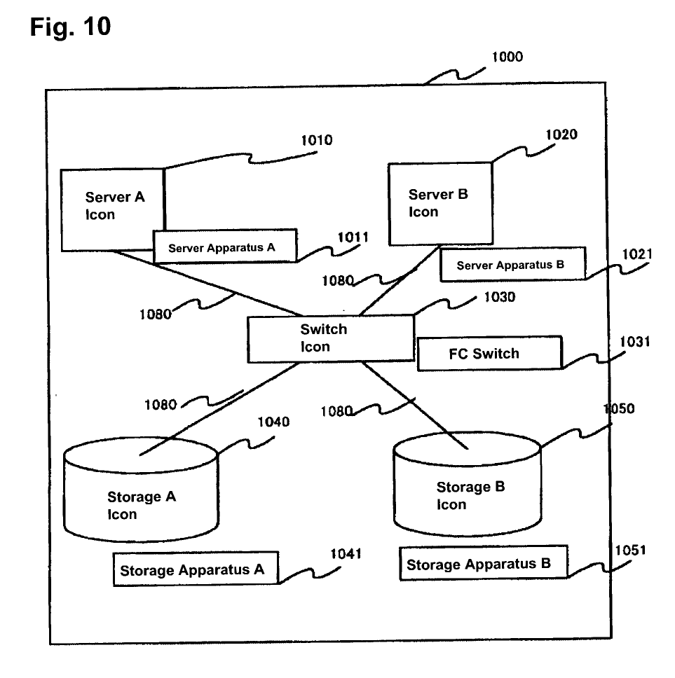

FIG. 10 shows an example of a topology diagram displayed on the management console screen 115 or the portable management console screen 116 of the present embodiment. In the topology diagram in FIG. 10, the respective apparatuses are expressed as icon images 1010, 1020, 1030, 1040 and 1050, and the state of connection is expressed with line segments 1080 on the basis of the names of remote apparatuses in the apparatus information table 900. Apparatus names 1011, 1021, 1031, 1041 and 1051 are shown near the icons.

Next, descriptions are made as to a method for displaying the topology diagram on the management console screen 115 and the portable management console screen 116 in the network composing apparatus specifying system in accordance with the present embodiment with reference to FIGS. 2-10.

First, a process of the management server apparatus 106 for acquiring apparatus connection information of the FC switch 103 will be described. When the management server apparatus 106 acquires apparatus connection information from the FC switch 103, the control unit 400 of the management server apparatus 106 transmits to the FC switch 103 a request to acquire apparatus connection information through the apparatus information and apparatus connection receiving unit 402 via the LAN communications unit 133.

The control unit 501 of the FC switch 103, which received the request to acquire connected apparatus information from the management server apparatus 106, will acquire via the FC communication unit 140 the WWN of each of the server apparatus A 101, the server apparatus B 102, the storage apparatus A 104 and the server apparatus B105 that are connected to its own FC ports, and create an apparatus connection information 800 shown in FIG. 8.

And, the control unit 501 of the FC switch 103, after it creates the apparatus connection information 800, returns the apparatus connection information 800 to the management server apparatus 106 via the LAN communication unit 130, and the apparatus information and apparatus connection information receiving unit 402 of the management server apparatus 106 receives the apparatus connection information 800 returned from the FC switch 103.

Next, a process of the management server apparatus 106 for acquiring apparatus information from the respective apparatuses will be described. When the management server apparatus 106 acquires apparatus information from the respective apparatuses, the control unit 400 of the management server apparatus 106 sends via the LAN communication unit 133 a request to the respective apparatuses to acquire apparatus information, using the apparatus information and apparatus connection information receiving unit 402.

Each of the apparatuses, upon receiving the request for apparatus information from the management server apparatus 106, returns to the management server apparatus 106 apparatus information 701-705 including at least the MAC address, apparatus name, WWN and fault information, shown in FIG. 7. The apparatus information and apparatus connection information receiving unit 402 of the management server apparatus 106 receives the apparatus information 701-705 returned from the respective apparatuses.

The control unit 400 of the management server apparatus 106 that receives the apparatus information 701-705 and apparatus connection information 800 in the manner described above, creates an apparatus information table 900 shown in FIG. 9 based on the WWNs commonly applicable to the apparatus information 701-705 and the apparatus connection information 800, using the apparatus information table control unit 404.

And, the control unit 400 of the management server apparatus 106, through using the apparatus information table preservation unit 105, preserves in a storage apparatus such as a memory in the management server apparatus 106 the apparatus information table 900 created by the apparatus information table control unit 404.

When the administrator makes a request (through keyboard operation or clicking of the mouse button) to display of the topology diagram on the management console 111, the control unit 302 of the management console 111 receives the request through the input unit 301. Using the screen image generating unit 311, the control unit 302 obtains the apparatus information table 900 retained by the apparatus information table preservation unit 405 of the management server apparatus 106, via the LAN communication unit 135. Then, a screen image 1000 similar to the one shown in FIG. 10 is created on the basis of the acquired apparatus information table 900.

In this event, if there is any fault information in the fault information column of the apparatus information table 900, a screen image with a mark such as “!”, indicating a fault problem in the apparatus, is created over the icon corresponding to the fault information. While the mark “!” is attached in the present embodiment to show a faulty apparatus, any other output may be used if the administrator is able to verify the apparatus having the fault in the topology diagram.

The control unit 302 of the management console 111 uses the display unit 303 to display the screen image 1000 created by the screen image generating unit 311 on the management console screen 115.

Also, when the control unit 202 of the portable management console 112 displays a screen image 1000 similar to the one shown in FIG. 10 on the portable management console screen 116, using the screen image generating unit 211, the same process described above for the management console 111 is performed. However, the difference is that, when the apparatus information table 900 is acquired from the management server apparatus 106, the wireless LAN communication unit 165 is used to acquire the apparatus information table 900, instead of the LAN communication unit.

In the mean time, the apparatus control unit 501 in accordance with the present embodiment continuously transmits apparatus identification numbers at all times from the apparatus identification transmitting unit 503 via the short-distance wireless communications unit 150. When the portable management console 112 approaches a target network composing apparatus to be managed within a range where short-distance wireless communication is possible, the control unit 202 of the portable management console 112 acquires the apparatus identification number from that network composing apparatus specifying system with its apparatus identification receiving unit 212, via the short-distance wireless communication unit 155.

In the present embodiment, this apparatus identification number is the MAC address, which is a number unique to the apparatus. The control unit 202 of the portable management console 112, which acquired this apparatus identification number, receives the apparatus information table 900 from the management server apparatus 106 with the screen image generating unit 211 via the wireless LAN communication unit 165.

And, by referring to the acquired apparatus information table 900 and searching and retrieving an icon image with the apparatus identification number by using the short-distance wireless communication unit 155, the control unit 202 of the portable management console 112 uses the screen image generating unit 211 to create a new screen image with the icon framed by a colored line such as a red line, and display the new screen image on the portable management console screen 116 by using the display unit 203.

By verifying the icon framed with the red line as described above, the administrator is able to confirm that the network composing apparatus correlated to the icon is the apparatus immediately in front of him.

While in the preceding explanation, the icon retrieved is framed by a red line, the present embodiment does not restrict the icon retrieved and displayed to this method. Any other display method may be used if the administrator is able to specify the particular icon by referring to the topology diagram.

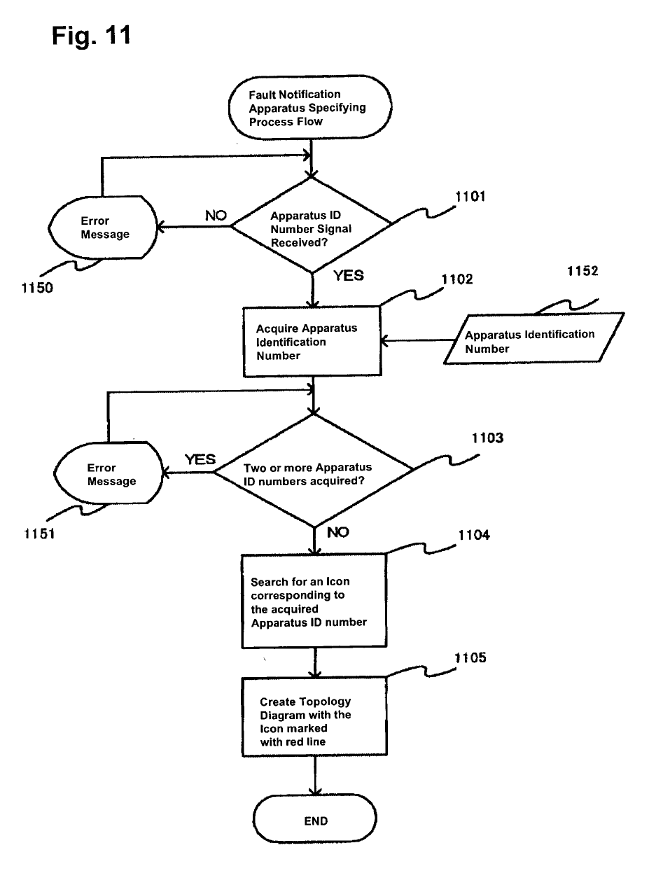

FIG. 11 is a flowchart showing processing steps for specifying network composing apparatuses in accordance with an embodiment of the present invention. Referring to FIG. 11, descriptions will be made as to the processing to specify the storage apparatus A 104 and the storage apparatus B 105 within the apparatus groups when a breakdown occurs simultaneously in the disk section of the storage apparatus A 104 and the disk section of the storage apparatus B105 in the network composing apparatus specifying system in accordance with the present embodiment.

First, a display method of displaying the topology diagram for notifying fault information will be described, and then a method for specifying the actual apparatuses corresponding to the faulty apparatuses displayed in the topology diagram will be described.

In the present embodiment, when a breakdown occurs in the disk section (not shown on the diagram) of the storage apparatus A 104, the control unit 501 of the storage apparatus A 104 detects the fault, and the fault notification transmitting unit 502 sends the MAC address (101) and fault information to the management server apparatus 106 via the LAN communication unit 130.

The control unit 400 of the management server apparatus 106 uses the fault notification receiving unit 403 to acquire the fault information and the MAC address (101) of the faulty apparatus from the LAN communication unit 133. Thereafter, it uses the apparatus information table control unit 404 to acquire the apparatus information table 900 preserved in the apparatus information table preservation unit 405.

Next, the control unit 400 of the management server apparatus 106 uses the apparatus information table control unit 404 to renew the apparatus information table 900 by writing in a fault code that indicates the breakdown in the disk section in the fault column on line 901 of the apparatus information table 900 in the MAC address (101) acquired from the faulty apparatus. This renewed apparatus information table 900 is then stored in the apparatus information table preservation unit 405.

Subsequently, the control unit 400 of the management server apparatus 106, using the apparatus information table change notification transmitting unit 401, transmits to the management console 111 or the portable management console 112 an apparatus information change notification, via the LAN communication unit 133 or the wireless LAN communication unit 160.

When the management console 111 or the portable management console 112 receives the apparatus information table change notice via the LAN communication unit 135 or wireless LAN communication unit 165, it uses the screen image generating unit 311 or the screen image generating unit 211 to create a new screen image with a “!” mark attached over the icon image 1040 that corresponds to the apparatus having the fault information, and uses the display unit 303 or the display unit 203 to display the image on the management console screen 115 or the portable management console screen 116.

Also, the same process is performed for the damaged disk of the storage apparatus B 105, and a topology diagram with a “!” mark attached over the icon image not only for the icon image 1040 but also over an icon image 1050 which are accommodated in the management console screen 115 and the portable management console screen 116.

When it is verified that the mark “!” is displayed on the icon images 1040 and 1050 in the topology diagram of the management console 115 or the portable management console 116, the administrator takes the portable management console 112 to the site where the apparatus groups are installed in order to rectify the fault in the actual apparatuses, and approach the portable management console 112 to one of the network composing apparatuses. However, if the damage is verified with the management console screen 115, the administrator may display the same topology diagram as the one on the management console screen 115 on the portable management console 116, then takes the portable management console 112 to the site of the apparatus groups, and approach the portable management console 112 to one of the network composing apparatuses.

In Step 1101, the apparatus identification number receiving unit 212 of the portable management console 112 checks if the signal indicating the apparatus identification number is received by the apparatus identification number receiving section 250, in other words, it checks whether the portable management console 112 is approaching the distance where short-distance communication is possible with one of the network composing apparatus. If it is not within communication range, the process proceeds to Step 1150 to display an error message such as “The apparatus cannot be specified” in the portable management console screen 116.

If the portable console is within the short-distance wireless communication range, the process proceeds to Step 1102. The apparatus identification number receiving unit 212 of the portable management console 112 acquires the apparatus identification number from the signal received by the apparatus identification number receiving section 250.

In Step 1103, the apparatus identification number receiving unit 212 of the portable management console 112 checks whether or not, in the acquisition of the apparatus identification number described above, two or more apparatus identification numbers have been acquired. If so, the process proceeds to Step 1151, and an error message such as “Approach closer to an apparatus” is displayed on the portable management console screen 116.

If only one apparatus identification number is acquired, the process proceeds to Step 1104. The screen image generating unit 211 of the portable management console 112 acquires the apparatus information table 900 from management server apparatus 106 via the wireless LAN communications unit 165. And, an apparatus identification number row 902 of the acquired apparatus information table 900 is searched, and an icon image among the records in which the apparatus identification number in the apparatus identification number row 902 coincides with the acquired apparatus identification number is retrieved.

And, in Step 1105, a screen image with the icon image framed in a red line is created, which is then displayed on the portable management console screen 116.

If the red-line framed icon is neither the icon image 1040 or 1050 marked with “1”, the network composing apparatus in the front of the administrator can be identified as not being the faulty apparatus. Therefore, the administrator may repeat the process of approaching other apparatuses until he verifies that the icon image 1040 or 1050 is displayed with the redline frame in order to specify the faulty apparatuses.

After the faulty apparatus has been specified, the administrator performs the task of removing the fault problem from the apparatus. In specifying the description of the fault problem during the task, the administrator may select the icon image 1040 framed by the red line on the topology diagram of the portable management console screen 116 if more detailed information on the fault is required, and call up a utility for storage apparatus. By so doing, the administrator is able to call up the utility to manage the apparatus in front (storage apparatus A) of him.

In other words, when the administrator selects the icon image 1040 framed by a red line on the topology diagram of the portable management console screen 116, and directs the execution of the utility, the portable management console 112 assists the task of removing the fault problem by executing the utility process associated with the apparatus identified by the apparatus identifier acquired, such as for example, calling up the disk diagnostic process for specifying the fault occurring in the disk section of the storage apparatus A104, and displaying the results on the portable management console screen 116.

As the apparatus identification number (MAC address 104) of the apparatus information table 900 is used to call out the utility, it is possible to avert such error as starting the utility for the wrong apparatus. Thus, the administrator is able to carry out the task efficiently by combining the results of the utility processing and the actual state of the faulty apparatus.

Also, if faulty problems occur in a plurality of apparatuses, including the FC switch 103, it is possible that a problem (for example a break down of the ports of the FC switch 103) could prevent the management console 111 or the portable management console 112 from displaying the correct fault information (as the management server apparatus being unable to acquire fault information from the network composing apparatuses connected to the faulty ports). In this case, the FC switch 103 must be first specified, and the fault problem removed. Then, after using the portable management console 112 to instruct the management server apparatus 106 to acquire new apparatus information and apparatus connection information, the renewed apparatus information table 900 is obtained from the management server apparatus 106. At that point, the process of displaying a new topology diagram may be performed so as to check whether a new “!” mark has been displayed to verify whether there are other faulty apparatuses.

Also, while the process described above is concerned with specifying faulty apparatuses, the process may be used to specify apparatuses other than the faulty ones, such as displaying on the topology diagram apparatuses whose prescribed maintenance period has expired and to specify the apparatuses that require maintenance service. In this case, a different type of process needs to be called out in accordance with the targets to be specified such as the utility process for maintenance. As for utilities to be called out after target apparatuses have been specified, these may be set in advance in accordance with specific reasons concerning fault occurrences, execution of maintenance services, and the types of target apparatuses such as server apparatuses and storage apparatuses.

Next, descriptions are made as to a process of specifying which of the apparatus corresponds to the icon in the topology diagram in the event some anomaly (noise, odor, etc.) occurs in an actual apparatus in spite of the fact that there is no display of the “!” mark indicating a fault problem in the topology diagram on the management console screen 115 or the portable management console screen 116 in the network composing apparatus specifying system in accordance with the present embodiment.

In this example, while a problem has occurred in the mechanism of the revolving disk in the hard disk section (not shown) of the storage apparatus A 104, generating an abnormal high frequency sound, the assumption here is that because the problem is not fatal, the control unit 501 of the storage apparatus A104 still has not detected it as a faulty problem.

In this case, an approaching method different from the preceding example will be explained, using FIG. 6, as a method for approaching the portable management console 112 to the apparatus.

As shown in FIG. 6, the surface of each of the apparatuses is provided with an apparatus identification number transmitting section 655 that sends a signal for apparatus identification number, and a communication section position indicator 650 that contains instructions for having the portable management console 112 approach the apparatus identification number transmitting section 655.

In one embodiment, let us assume that the communication section position indicator section 650 holds a written instruction or character strings such as “Hold the portable management console close to this point” placed on a sticker. This display shall be unified for all apparatuses. Also, when installing the apparatuses, it is recommended that some distance be maintained between the short-distance wireless communication units 150 of the adjacent apparatuses such that signals from adjacent apparatuses cannot reach the short-distance wireless communication unit 150 provided on the surface of another apparatuses. This will avoid erroneous operations such as the portable management console 112 acquiring two or more apparatus identification numbers,

Also, the portable management console 112 has on its surface an apparatus identification number receiving section 250 for receiving signals indicating apparatus identification numbers. The administrator obtains the apparatus identification number by placing the apparatus identification number receiving section 250 attached to the surface of the portable management console 112 on or close to the apparatus identification number transmitting section 655 on the apparatus surface as indicated by the communication section position indicator section 650.

When the control unit 501 of the storage apparatus A104 is unable to detect the abnormal noise from the hard disk section of the storage apparatus A104 as a fault, it will not use the fault communication transmitting unit 502 to transmit the fault notification to the management server apparatus 106.

Because of this, the administrator is unable to obtain any fault information from the topology diagram of the management console screen 115 or the portable management console screen 116. But in actually making the rounds of the site where the apparatuses are installed, the administrator may detect the noise being generated by an apparatus.

In this case, the administrator may take the portable management console 112 that displays the topology diagram, verify the position of the apparatus identification number transmitting section 655 with the communication section position indicator 650 of the apparatus emitting the noise, and move the apparatus identification number receiving section 250 of the portable management console 112 to the apparatus identification transmitting section 655.

On receiving the apparatus identification number via the short-distance wireless communication unit 150 by the apparatus identification number receiving unit 212, the control unit 202 of the portable management console 112 searches for the corresponding icon image of the apparatus identification number received as in the case of the previous process, and a topology diagram is newly created with the icon thus retrieved and with the icon framed in red line, and displayed on the portable management console screen 116.

By verifying that the icon framed in red line is the icon image 1040 of the storage apparatus A 104, the administrator is able to recognize that the apparatus emitting the strange noise in front of him is the storage apparatus A 104.

When the administrator selects the icon image 1040 framed by the red line on the topology diagram in the portable management console screen 116, and instructs an execution of a utility, the portable management console 112 calls out a utility process associated with the apparatus identified by the previously mentioned apparatus identifier, for example, a process for displaying the maintenance service records and/or the lapsed days from the previous parts replacement for the storage apparatus A104, and displays the results on the portable management console screen 116 to assist in the maintenance service before a fatal problem occurs. The administrator is able to promote his work efficiently by taking stock of the entire situation, including the data concerning the time (i.e., days, weeks, etc.) lapsed since the parts were replaced on the previous occasion, the maintenance service records and the actual state of the apparatus emitting noise or odors.

As explained above, the network composing apparatus specifying system in accordance with the present embodiment enables enhancing efficiency in operating and managing the network because the icons of the apparatuses arranged in the diagram showing the network configuration are matched with the actual apparatuses.

The following is an explanation of a network composing apparatus specifying system in accordance with a second embodiment that specifies which icons in the topology diagram showing the storage network configuration correspond to the actual apparatuses.

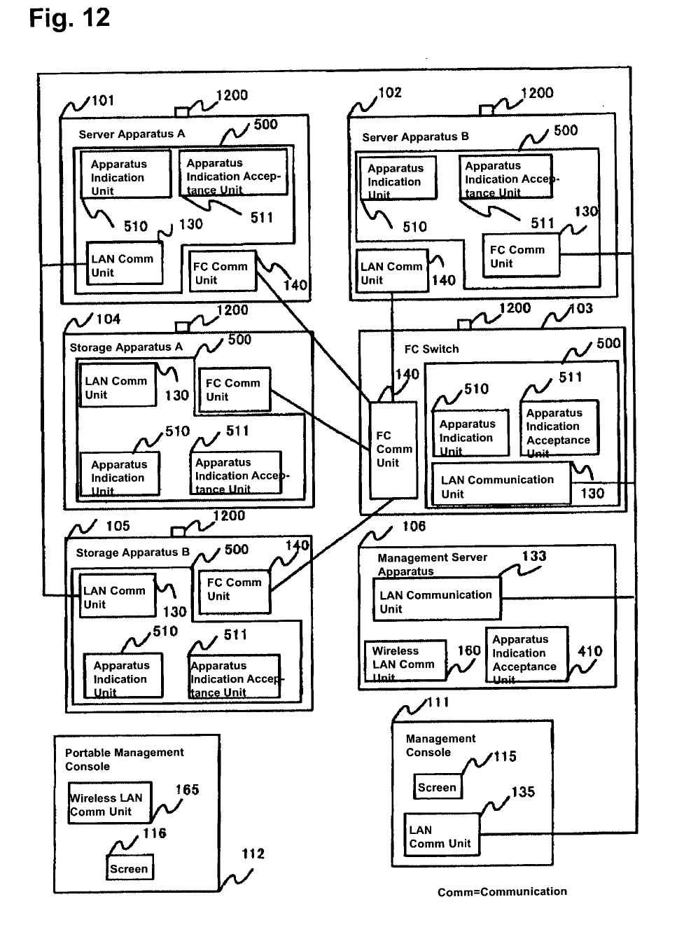

FIG. 12 shows an example of the network composing apparatus specifying system in accordance with the second embodiment of the present invention. As shown in FIG. 12, the network composing apparatus specifying system is provided with a management server apparatus 106 that includes an apparatus indication control unit 410. The apparatus indication control unit 410 is a processing section that acquires apparatus identification numbers from a management console 111 or a portable management console 112, and transmits to apparatuses that are identified by the acquired apparatus identification numbers requests to execute or end the indication of apparatus identification for identifying apparatuses.

The apparatus indication control unit 410 may be implemented by a program that renders the management server apparatus 106 to function as the apparatus indication control unit 410. The program may be first recorded in a recording medium such as a CD-ROM or stored in a magnetic disk. The program is then loaded on a memory and executed. Also, the recording medium for storing the program mentioned above may be a recording medium other than a CD-ROM or a magnetic disk. Also the program may be executed after installing it in an information processing apparatus from the recording medium. Or, the program may be executed through accessing the recording medium via the network.

Each of the network composing apparatuses has an apparatus indication unit 510 and an apparatus indication acceptance unit 511.

The apparatus indication unit 510 is a processing section that receives from the management server apparatus 106 a request to execute the apparatus identification indication to identify the apparatus and indicates the identification of the apparatus. The apparatus indication acceptance unit 511 is a processing section that transmits to the source requesting the indication of the apparatus identification a completion notice indicating that the apparatus has executed the apparatus identification indication.

The apparatus indication unit 510 or the apparatus indication acceptance unit 511 may be implemented by a program that renders the network composing apparatus to function as the apparatus indication unit 510 or the apparatus indication acceptance unit 511. The program may be executed after being stored in a recording medium such as a non-volatile memory. Recording media other than a non-volatile memory may be used to store the program. Moreover, the program may be used after installing it onto an information processing apparatus from the recording medium, or by accessing the recording medium via the network.

The network composing apparatus specifying system in accordance with the second embodiment is formed from a group of network composing apparatuses similar to those of the first embodiment (e.g., a portable management console 112, server apparatus A 101, server apparatus B 102, FC switch 103, storage apparatus A 104, storage apparatus B 105, management server apparatus 106 and management console 111).

Also, like the first embodiment, the administrator uses the management console 111 and/or the portable management console 112 to manage the topology and the fault problems of groups of network composing apparatuses (hereafter referred to as “apparatus groups”, with the individual apparatus being referred to as an “apparatus”) such as the server apparatus A 101, the server apparatus B 102, the FC switch 103, the storage apparatus A 104 and the storage apparatus B 105, using the topology diagram on the management console screen 115 and/or the portable management console screen 116.

In this embodiment, instead of the short-distance wireless communication unit 150 provided in each of the apparatuses shown in the system configuration of FIG. 1 of the first embodiment, an apparatus indicating unit 510, an apparatus indicating acceptance unit 511 and an apparatus indication section 1200 for operating light emission and voice output as a way of indicating the identification of the respective apparatus are newly implemented. In this case, the apparatus indication section 1200 may be formed from light emitting diodes (LEDs) installed on the surface of the apparatus. While the other configuration of the respective apparatuses may be the same as that of the first embodiment, the apparatus identification number transmitting unit 503 and the apparatus identification number transmitting section 655 may not be used in this embodiment.

Also, the management server apparatus 106 used in this embodiment, is additionally provided with an apparatus indication unit 410, but the other configuration may be the same as that of the first embodiment.

Next, descriptions are made as to operations of the management console 111 and the portable management console 112 when the icon is selected for the topology diagram in the network composing apparatus specifying system in accordance with the present embodiment.

When the administrator selects (the selection may be made by clicking the mouse button or inputting from the keyboard) an icon from the topology diagram in the management console screen 115, the control unit 302 of the management console 111 acquires an apparatus information table 900 from the management server apparatus 106 via the LAN communication unit 135.

The control unit 320 which acquired the apparatus information table 900 searches for one MAC address corresponding to the selected icon, and transmits the MAC address to the management server apparatus 106 via the LAN communication unit 135.

Similarly, when the administrator selects an icon in the topology diagram in the portable management console screen 116, a MAC address corresponding to the selected icon is transmitted from the portable management console 112 to the management server 106 via the wireless LAN communication unit 165.

When the control unit 400 of the management server apparatus 106 receives the MAC address, the apparatus identification number, from the management console 111 or the portable management console 112, the apparatus indication acceptance unit 410, transmits to the corresponding apparatus via the LAN communication unit 133 a request to turn on or off the apparatus indication section 1200 (LED), or a request to verify if the apparatus indication section 1200 has been turned on or off.

Upon receiving the request to turn on the light from the management server apparatus 106, the control unit 501 of the apparatus uses the apparatus indication unit 510 to light the apparatus indication section (LED), and transmits a light-turned on completion notice indicating the completion of lighting to the management server apparatus 106 via the LAN communication unit 130. When the management server apparatus 106 cannot acquire the lighting completion notice, the management server apparatus 106 is able to determine that a problem has occurred in the communication unit between itself and the apparatus.

Also, upon receiving a request from the management server apparatus 106 to turn off the light, the control unit 501 of the apparatus uses the apparatus indication unit 510 to turn off the apparatus indication section 1200 (LED), and transmits a light-turned off completion notice indicating that the light has been turned off to the management server apparatus 106 via the LAN communication unit 130. When the management server apparatus 106 cannot acquire the notice, the management server apparatus 106 may determine that a problem has occurred in the communication unit between itself and the apparatus.

Moreover, when the control unit 501 of the apparatus receives a request from the management server apparatus 106 to verify that the lamp is turned on, the apparatus indication unit 510 judges whether or not the LED lamp on the apparatus indication section 1200 is lit, and transmits a light-turned on code when the lamp is turned on, or a light-turned off code when the lamp is turned off via the LAN communication unit 130 to the management server apparatus 106. If the management server apparatus 106 receives the light-turned off code, the LED lamp section (not shown in the drawings) of the apparatus identification section 1200 may judge that a fault has occurred.

Also, when the control unit 501 of the apparatus receives a request from the management server apparatus 106 to verify that the lamp is turned off, the apparatus indication unit 510 determines whether or not the LED lamp on the apparatus indication section 1200 is turned off, and sends a light-turned on code when the lamp is turned on and a light-turned off code when the lamp is turned off via the LAN communication unit 130 to the management server apparatus 106. When the management server apparatus 106 receives a light-turned on code indicating that the lamp is on, it may judge that a fault has occurred in an LED-turning off section (not shown in the drawings) of the apparatus indication section 1200.

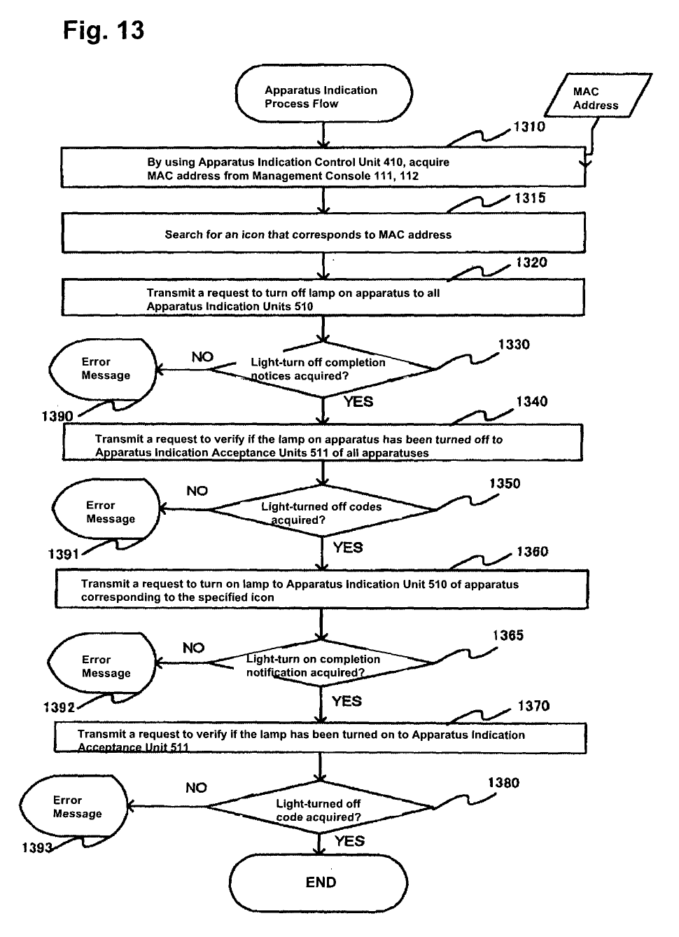

FIG. 13 is a flowchart of steps of a process for indicating network composing apparatus' identifications in accordance with the present embodiment. Referring to the flowchart in FIG. 13, descriptions are made as to a process of specifying an apparatus corresponding to its icon by turning on the apparatus indication section 1200 (LED) of the corresponding apparatus, which takes place when the administrator selects an icon in the topology diagram of the management console screen 115 or the portable management console screen 116.

The control unit 400 of the management server apparatus 106 receives a MAC address from the management console 111 or the portable management console 112 via the LAN communication unit 133 or the wireless LAN communication unit 160. (Step 1310).

The control unit 400 of the management server apparatus 106, which has acquired the MAC address, obtains the apparatus information table 900 from the apparatus information table preservation unit 405 and searches for an apparatus corresponding to the MAC address in the apparatus information table 900 (Step 1315).

The control unit 400 of the management server apparatus 106, which has specified the apparatus, uses the apparatus identification control unit 410 to send a request to turn off the LED to all of the apparatuses via the LAN communication unit 133 (Step 1320).

The management server apparatus 106 determines (Step 1330) whether it has received light-turned off completion notices from all of the apparatuses. When even one completion notice is not received, the management server apparatus 106 transmits an error message 1390 to the management console 111 or the portable management console 112. The control unit 400 of the management server apparatus 106, when it receives light-turned off completion notices from all of the apparatuses, uses the apparatus indication control unit 410 to send a request to verify that the LED lights are positively off to all of the apparatuses via the LAN communication unit 133 (Step 1340).

The control unit 400 for the management server apparatus 106 uses the apparatus indication control unit 410 to determine whether light-turned off codes have been received from all of the apparatuses (Step 1350). When even a single light-turned on code is received, the management server apparatus 106 sends an error message 1391 to the management console 111 or the portable management console 112.

The control unit 400 of the management server apparatus 106, which has received the light-turned off codes from all apparatuses, uses the apparatus indication control unit 410 to send a request to turn on the LED lamp (Step 1360) to the apparatus specified in Step 1315.

The management server apparatus 106 determines whether the light-turned on completion notice has been received from the apparatus (Step 1365), and sends an error message 1392 to the management console 111 or the portable management console 112 if the light-turned on completion notice has not been received.

When the light-turned on completion notice is received, the control unit 400 of the management server apparatus 106 sends a request to verify that the LED lamp is positively lit to the apparatus via the LAN communication unit 133 (Step 1370), and determines whether or not a light-turned on code or a light-turned off code has been received (Step 1380).

If a light-turned off code is received, an error message 1393 is sent to the management console 111 or the portable management console 112. If a light-turned on code is received, which means that the LED lamp of the single apparatus corresponding to the icon selected by the administrator in the topology diagram has been lit, this concludes the process for indicating the identification of the apparatus.

As described above, when the administrator selects an icon on the topology diagram, the LED lamps on all of the apparatuses are turned off when the LED on even a single apparatus is on, and the apparatus indication section 1200 (LED) for only the apparatus corresponding to the selected icon is turned on, such that the administrator is able to efficiently specify the apparatus corresponding to the selected icon

For example, as in the case of the first embodiment, if faults occur in both of the storage apparatus A 104 and the storage apparatus B 105, the administrator verifies that the “!” mark is attached to the icon images 1040 and 1050 on the topology diagram of the portable management console screen 116, and selects either of the two icons by a screen operation. Then, the fault apparatus is easily specified by turning on the LED light only on the apparatus corresponding to the selected icon.

Also, if more detailed fault information is required on specifying the apparatus' fault description, a utility that manages the apparatus with the LED lamp being lit can be called out by calling the utility for the icon selected on the topology diagram of the portable management console screen 116. As the apparatus identification number in the apparatus information table 900 is used for calling out the utility, errors such as an error of starting a utility for a wrong apparatus can be avoided.

As described above, when a portable management console is brought close to an actual network composing apparatus, short-distance wireless communication units installed on both of the portable management console and the network composing apparatus that is managed by the management console transmit and receive an apparatus identification number to thereby change the display of an icon in the topology diagram on the portable management console screen which corresponds to the actual apparatus in front and indicate the identification of the actual apparatus corresponding to the selected icon. With this, the administrator can verify which apparatus in the topology diagram is the apparatus immediately in front of him, and which apparatus immediately in front him corresponds to the apparatus in the topology diagram. As a result, the time for specifying the apparatuses can be reduced. Especially, when the administrator recognizes a fault in the topology diagram, it is possible to call out more detailed fault information onto the management console screen, in addition to saving time in specifying the faulty apparatus. Therefore, it is possible to provide a management operation environment that smoothly rectifies the problem and enables a smooth recovery of the system.

Also, during a routine inspection of apparatuses composing the network, the administrator with a portable management console may notice that, while some anomaly can be detected in an actual apparatus, but there is no fault reported in the management console, he can bring the portable management console closer to the position where the apparatus with the anomaly is located. This would change the icon corresponding to the apparatus on the portable management console screen. As a result, it is possible to specify the name of the apparatus showing the anomaly. And, by operating the icon, it is possible to obtain more detailed information concerning the apparatus on the spot. Therefore, it is possible to provide a management operation environment which allows tracing of the cause of the anomaly on the spot.

Also, since the same effect describe above can be obtained by simply bringing a portable management console close to apparatuses or by merely selecting an icon on the topology diagram on the management console screen, even when the method of arranging network composing apparatuses is changed, or when the installation site of the apparatuses is changed. Accordingly, it is possible to provide a management operational environment in which apparatuses can be readily specified regardless of whether the apparatuses are moved from one place to another.

As described above, with the network composing apparatus specifying system in accordance with the embodiments of the present invention, the efficiency in operating and managing the network can be enhanced, because a pattern representative of an apparatus arranged in a diagram showing a network configuration is matched with the actual apparatus.

In accordance with the present invention, as an icon representative of an apparatus among a plurality of apparatuses arranged in a diagram showing a network configuration is matched with the actual apparatus, the efficiency of operating and managing the network can be enhanced.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A method for specifying an apparatus composing a network, the method comprising the steps of:
transmitting from an apparatus an apparatus identifier for specifying the apparatus composing the network;
receiving the apparatus identifier transmitted from the apparatus;
referring to an apparatus information table indicating correlation between apparatus identifiers of a plurality of apparatuses composing the network and patterns disposed in a network configuration diagram to search for a pattern corresponding to the apparatus identifier received; and
creating a screen image indicating which of the patterns in the network configuration diagram corresponds to the searched pattern.

2. A method according to claim 1, further comprising the steps of performing an indication of an apparatus having a fault among the plurality of apparatuses composing the network on the network configuration diagram, and indicating whether or not the searched pattern corresponds to the apparatus having the problem to support identifying the apparatus having the problem.

3. A method according to claim 1, further comprising the step of receiving the apparatus identifier transmitted from the apparatus via a wireless communication within a predetermined range.

4. A method according to claim 1, further comprising the steps of always transmitting apparatus identifiers from the respective plurality of apparatuses, and displaying a message for receiving a single apparatus identifier when multiple apparatus identifiers are received.

5. A method according to claim 1, further comprising the step of creating a picture image with a modification added to the searched pattern.

6. A method for specifying an apparatus composing a network, the method comprising the steps of:
acquiring an apparatus identifier for identifying an apparatus composing the network;
transmitting to the apparatus identified by the acquired apparatus identifier an execution request to make an apparatus indication for identifying the apparatus;
executing the apparatus indication for identifying the apparatus upon reception of the execution request to make the apparatus indication; and
transmitting to a source that requests to make the apparatus indication for identifying the apparatus a completion notice indicating that the apparatus has executed the apparatus indication.

7. A method according to claim 6, further comprising the steps of referring to an apparatus information table indicating correlation between apparatus identifiers of a plurality of apparatuses composing the network and patterns disposed in a network configuration diagram, and designating an apparatus identifier corresponding to one of the patterns selected from the network configuration diagram as an apparatus identifier of the apparatus.

8. A method according to claim 6, wherein the apparatus indication for identifying the apparatus lights an LED unit on the apparatus that receives the execution request.

9. A method according to claim 6, further comprising the steps of transmitting an end request to end the apparatus indication to the plurality of apparatuses other than the apparatus identified by the apparatus identifier, and performing an exclusive apparatus identification to make an indication for exclusively identifying the apparatus identified by the apparatus identifier.

10. A method according to claim 6, further comprising the step of calling up an utility process associated with the apparatus identified by the apparatus identifier.

11. A network management system that specifies an apparatus composing a network, the network management system comprising:
at least one equipment composing the network, the equipment having an apparatus identifier transmitter that transmits an apparatus identifier for identifying the apparatus; and
at least one portable management console having an apparatus identifier receiving unit that receives the apparatus identifier transmitted from the apparatus, and a screen image creating unit that refers to an apparatus information table indicating correlation between apparatus identifiers of a plurality of apparatuses composing the network and patterns disposed in a network configuration diagram to search for a pattern corresponding to the apparatus identifier received, and then creates a screen image indicating which of the patterns in the network configuration diagram corresponds to the searched pattern.

12. A network management system according to claim 11, wherein the equipment comprises an apparatus identifier transmitter section that transmits a signal representative of the apparatus identifier for identifying the apparatus, and a communicating position indicator that indicates the position of the apparatus identifier transmitter section, wherein the portable management console comprises an apparatus identifier receiver section on a surface thereof that receives the apparatus identifier transmitted from the apparatus identifier transmitter section.

13. A network management system according to claim 12, wherein the apparatus identifier receiver section provided on the surface of the portable management console receives the apparatus identifier transmitted from the apparatus identifier transmitter section only when the apparatus identifier receiver section is positioned within a specified range from the apparatus identifier transmitter section indicated by the communicating position indicator on the apparatus.

14. A network management system according to claim 13, wherein the specified range is shorter than a distance between the apparatus and another apparatus disposed next to the apparatus.

15. A network management system that specifies an apparatus composing a network, the network management system comprising:
a management server apparatus having an apparatus indication control unit that acquires an apparatus identifier for identifying an apparatus composing the network, and transmits an execution request to make an indication for identifying the apparatus; and
at least one apparatus having an apparatus indication unit that receives the execution request, and performs an indication for identifying the apparatus in response to the execution request, and an apparatus indication acceptance unit that transmits a completion notice indicating that the apparatus has executed the indication for identifying the apparatus to a source that has made the execution request to make the indication for identifying the apparatus.

16. A program that renders a computer to function as a network management system that specifies an apparatus composing a network, the program comprising processes that function the computer as:
an apparatus identifier transmitter that transmits from an apparatus composing the network an apparatus identifier for identifying the apparatus;
an apparatus identifier receiving unit that receives the apparatus identifier transmitted from the apparatus; and
a screen image creating unit that refers to an apparatus information table indicating correlation between apparatus identifiers of a plurality of apparatuses composing the network and patterns disposed in a network configuration diagram to search for a pattern corresponding to the apparatus identifier received, and then creates a screen image indicating which of the patterns in the network configuration diagram corresponds to the searched pattern.

17. A program that renders a computer to function as a network management system that specifies an apparatus composing a network, the program comprising processes that function the computer as:
an apparatus indication control unit that acquires an apparatus identifier for identifying an apparatus composing the network, and transmits an execution request to make an indication for identifying the apparatus to the apparatus identified by the acquired apparatus identifier; and
an apparatus indication unit that receives the execution request, and performs an indication for identifying the apparatus in response to the execution request; and
an apparatus indication acceptance unit that transmits a completion notice indicating that the apparatus has executed the indication for identifying the apparatus to a source that has made the execution request to make the indication for identifying the apparatus.

18. A method for operating a network management system including a plurality of apparatuses composing a network, the method comprising the steps of:
creating an apparatus information table that stores at least apparatus identifiers unique to the respective apparatuses composing the network and icon patterns representative of the apparatuses, fault information that indicates whether or not the apparatuses are faulty, and information of the apparatuses connected;
generating a topology diagram with the icon patterns based on the apparatus information table and displaying the topology diagram on a display;
receiving an apparatus identifier from one of the apparatuses;
referring to the apparatus information table to search for an icon pattern corresponding to the apparatus identifier received; and
indicating the icon patter corresponding to the apparatus identifier with a specified mark.

19. A method for operating a network management system according to claim 18, further comprising the steps of bringing an apparatus identifier receiving unit in proximity to said one of the apparatuses and receiving with the apparatus identifier receiving unit the apparatus identifier transmitted from said one of the apparatuses.

20. A method for operating a network management system according to claim 19, wherein said one of the apparatuses transmits the apparatus identifier via a short-distance wireless communication.
